(19) United States
(12) Patent Application Publication
(10) Pub. No.: US 2021/0215388 A1
(43) Pub. Date: Jul. 15, 2021

(54) Air Purifying Device Having a Compatible Lower Body

(71) Applicant: MIRO CO., LTD., Incheon (KR)

(72) Inventors: Dong Jin SEO, Incheon (KR); Yong Ju OH, Incheon (KR); Min Seok KIM, Incheon (KR)

(21) Appl. No.: 16/623,673

(22) PCT Filed: Nov. 22, 2019
(86) PCT No.: PCT/KR2019/016074

§ 371 Date: Jan. 23, 2020

(30) Foreign Application Priority Data
Nov. 14, 2019 (KR) 10-2019-0145961

(51) Int. Cl. F24F 13/20; F24F 8/108; F24F 8/90; F24F 11/30; F24F 13/28

(52) U.S. Cl. CPC F24F 13/20; F24F 8/108; F24F 8/90; F24F 2221/36; F24F 13/28; F24F 2013/205; F24F 11/30

(57) ABSTRACT

An air purification device including an interchangeable lower body according to an exemplary embodiment of the present invention includes: an upper body opened at an upper portion thereof, selectively having therein an electronic circuit configured to operate the air purification device, and having, at the upper portion thereof, an air discharge unit configured to discharge purified air, the upper body being configured to be connected to one of interchangeable lower bodies having different capacities; and the lower body opened at an upper portion thereof and coupled to the upper body by being brought into contact with a lower portion of the upper body, the lower body having a vacant space into which a filter configured to purify air is inserted, selectively having therein an electronic circuit configured to operate the air purification device, and having an air intake unit provided on an outer surface thereof to draw in contaminated air.

### TECHNICAL FIELD

The present invention relates to an air purification device, and more particularly, to an air purification device which is mounted with a dual-structure fan cover, may cooperate with an IoT module, and includes an interchangeable lower body.

### BACKGROUND ART

An air purification device refers to a device configured to draw in contaminated air, purify the air, and then discharge the purified air. As an example, the air purification device may include a blower configured to introduce outside air into the air purifier, and a filter configured to filter out dust or bacteria contained in air. Examples of the air purification device include air cleaners, air purifiers, air washers, and devices for purifying air.

In general, the air purification device may have a cover member mounted to protect the blower. The cover member is easily exposed to external foreign substances, and thus the cover member needs to be periodically replaced or cleaned.

However, in most cases, the cover member in the related art is coupled integrally with a body of the air purification device. The air purification device has a structure in which it is difficult to detach only the cover member separately.

Therefore, there is a need for developing a technology that allows the cover member of the blower used for the air purification device to be easily separated and used.

As a related art, there is Korean Patent Application Laid-Open No. 10-1998-0083612 entitled Electronic Air Cleaner Having Fan (published on Dec. 5, 1998).

### DISCLOSURE

### Technical Problem

An object of the present invention is to provide an air purification device having a dual fan cover structure, in which a dual-structure fan cover is detachably mounted on an air discharge unit of the air purification device, such that a fan may be separately detached and easily cleaned.

In addition, another object of the present invention is to provide an air purification device having a dual fan cover structure, which may intelligently operate while cooperating with a peripheral IoT module via a wireless chip provided in the air purification device.

In addition, still another object of the present invention is to provide an air purification device having various capacities implemented by using lower bodies having different sizes, filters corresponding to the sizes of the lower bodies, and a single upper body.

Technical problems to be solved by the present invention are not limited to the above-mentioned technical problem(s), and other technical problem(s), which are not mentioned above, may be clearly understood by those skilled in the art from the following descriptions.

### Technical Solution

An air purification device including an interchangeable lower body according to an exemplary embodiment of the present invention includes: an upper body opened at an upper portion thereof, selectively having therein an electronic circuit configured to operate the air purification device, and having, at the upper portion thereof, an air discharge unit configured to discharge purified air, the upper body being configured to be connected to one of interchangeable lower bodies having different capacities; and the lower body opened at an upper portion thereof and coupled to the upper body by being brought into contact with a lower portion of the upper body, the lower body having a vacant space into which a filter configured to purify air is inserted, selectively having therein an electronic circuit configured to operate the air purification device, and having an air intake unit provided on an outer surface thereof to draw in contaminated air.

In addition, the air intake unit according to the exemplary embodiment of the present invention may be provided on an entire surface along an outer circumference of the lower body and may draw in the contaminated air in all directions at 360 degrees.

In addition, the lower bodies according to the exemplary embodiment of the present invention may be implemented to have different sizes and to be interchangeable.

In addition, in the exemplary embodiment of the present invention, a rotational speed of a fan of the air purification device may be automatically set based on a capacity of the interchangeable lower body.

In addition, a separation member having a label shape may be provided on an upper circumference of the filter in order to lift up and separate the filter from the lower body according to the exemplary embodiment of the present invention.

In addition, a part of the separation member according to the exemplary embodiment of the present invention may be exposed to the outside in a state in which the filter is inserted into the lower body.

In addition, the air discharge unit according to the exemplary embodiment of the present invention may include: a blower fan provided in the upper body and configured to induce a flow of air so that the purified air is discharged to the outside; a first fan cover provided on the upper portion of the upper body and configured to cover a front side of the blower fan; and a second fan cover provided on an upper portion of the first cover and configured to doubly cover the blower fan.

In addition, in the exemplary embodiment of the present invention, the first fan cover may include a first discharge port in the form of a mesh, and the second fan cover may include a second discharge port having slits formed at an equal interval.

In addition, the lower body and the upper body according to the exemplary embodiment of the present invention are coupled by means of magnetic members having different magnetic polarities and provided on a circumferential surface of the lower body and a circumferential surface of the upper body which are brought into contact with each other.

In addition, a slot portion may be provided in a circumferential surface of the upper body according to the exemplary embodiment of the present invention, and a chip configured to cooperate with an IoT (Internet of things) module may be mounted in the slot portion.

In addition, at least one of a temperature/humidity sensor configured to detect a temperature/humidity environment outside or inside the air purification device and a dust sensor configured to detect an environment of outside air quality may be provided on a circumference of the upper body according to the exemplary embodiment of the present invention, and the air purification device may further include a control unit configured to control an operation of the air purification device based on detection results of the temperature/humidity sensor and the dust sensor.

Other detailed matters of the exemplary embodiment are included in the detailed description and the accompanying drawings.

### Advantageous Effects

According to the exemplary embodiments of the present invention, the dual-structure fan cover is detachably mounted on the air discharge unit of the air purification device, such that the fan may be separately detached and easily cleaned.

In addition, according to the exemplary embodiments of the present invention, the air purification device may intelligently operate while cooperating with the peripheral IoT module via the wireless chip provided in the air purification device.

In addition, according to the exemplary embodiments of the present invention, the air purification device may be adaptively managed by using the same upper body and changing the lower bodies having different capacities or sizes. For example, when the lower body used in the related art is replaced with a lower body having a filter having a large size, the coverage and the purification ability of the air purification device may be improved even though the same electric power is supplied to the upper body including the intake fan. Furthermore, the multiple lower bodies having different sizes may be applied to the single upper body, such that various product groups of air purification devices may be implemented only by using the single upper body.

### DESCRIPTION OF DRAWINGS

FIG. 1 is an exploded perspective view for explaining an air purification device including an interchangeable lower body according to an exemplary embodiment of the present invention.

FIG. 2 is a perspective view for explaining the lower body of the air purification device including the interchangeable lower body according to the exemplary embodiment of the present invention.

FIG. 3 is a perspective view for explaining a filter of the air purification device including the interchangeable lower body according to the exemplary embodiment of the present invention.

FIG. 4 is a perspective view for explaining an upper body of the air purification device including the interchangeable lower body according to the exemplary embodiment of the present invention.

FIG. 5 is an exploded perspective view of the upper body illustrated to explain a dual fan cover structure of the air purification device according to the exemplary embodiment of the present invention.

FIGS. 6A to 6C are front views for explaining a process of disassembling the air purification device including the interchangeable lower body according to the exemplary embodiment of the present invention.

### DESCRIPTION OF MAIN REFERENCE NUMERALS OF DRAWINGS

10: Air purification device

100: Lower body

110: Air intake unit

120: Contact unit

200: Filter

300: Upper body

320: Air discharge unit

322: First fan cover

323: First discharge port

324: Second fan cover

325: Second discharge port

400: Separation member

500: Slot portion

600: Wheel

700: Sensor unit

### BEST MODE

Advantages and/or features of the present invention and methods of achieving the advantages and features will be clear with reference to exemplary embodiments described in detail below together with the accompanying drawings. However, the present invention is not limited to the exemplary embodiments disclosed herein but will be implemented in various forms. The exemplary embodiments of the present invention are provided so that the present invention is completely disclosed, and a person with ordinary skill in the art can fully understand the scope of the present invention. The present invention will be defined only by the scope of the appended claims. Like reference numerals indicate like constituent elements throughout the specification.

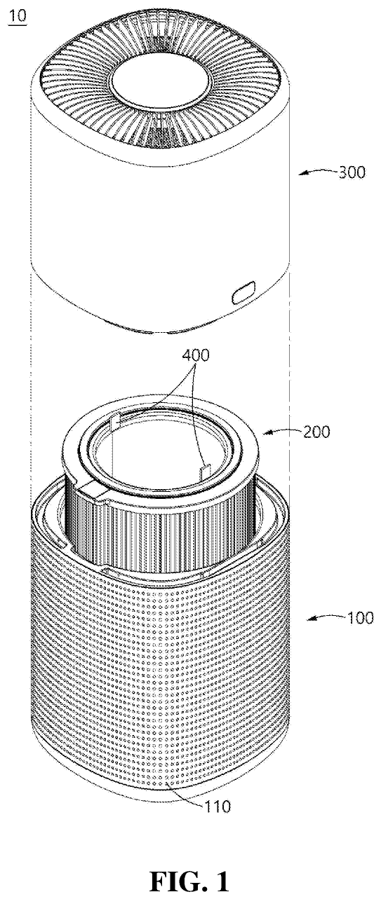

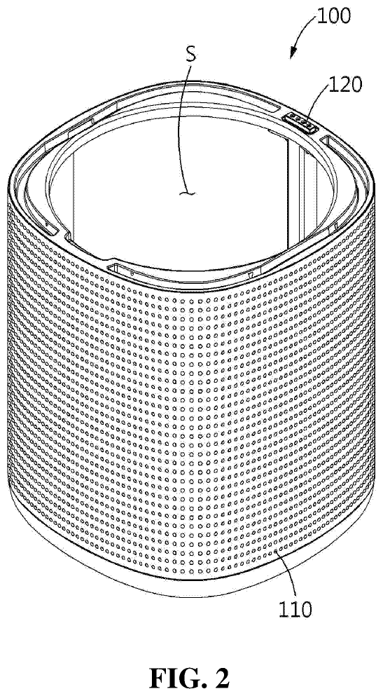

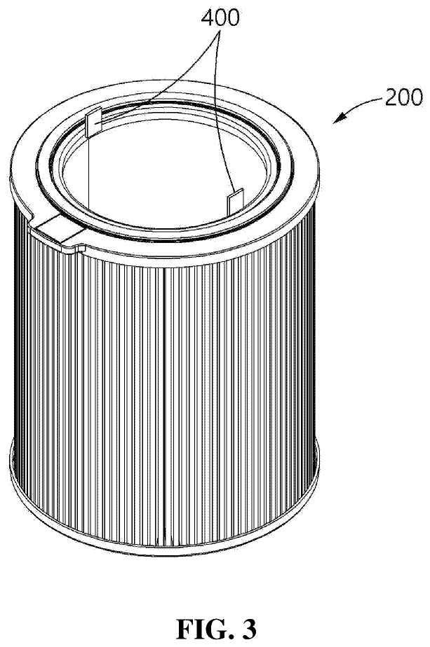

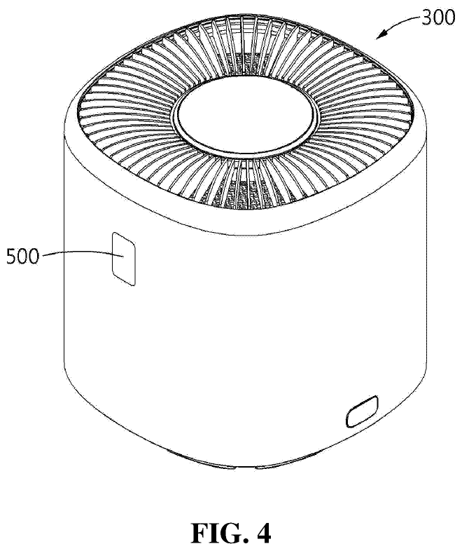

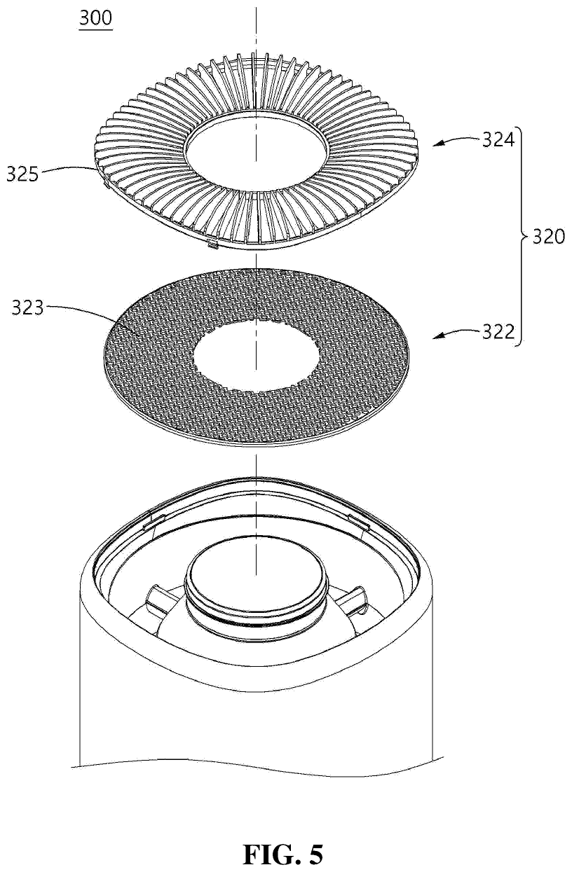

FIG. 1 is an exploded perspective view for explaining an air purification device including an interchangeable lower body according to an exemplary embodiment of the present invention, FIG. 2 is a perspective view for explaining the lower body of the air purification device including the interchangeable lower body according to the exemplary embodiment of the present invention, FIG. 3 is a perspective view for explaining a filter of the air purification device including the interchangeable lower body according to the exemplary embodiment of the present invention, FIG. 4 is a perspective view for explaining an upper body of the air purification device including the interchangeable lower body according to the exemplary embodiment of the present invention, and FIG. 5 is an exploded perspective view of the upper body illustrated to explain a dual fan cover structure of the air purification device including the interchangeable lower body according to the exemplary embodiment of the present invention. An air purification device disclosed in the present invention may include an air cleaner and an air purifier.

Referring to FIGS. 1 to 4, an air purification device 10 including an interchangeable lower body according to an exemplary embodiment of the present invention may include a lower body 100 and an upper body 300.

Prior to the description, the air purification device 10 according to the present invention may include the lower body 100 and the upper body 300 which are two separable bodies coupled to each other and operate.

The lower body 100 is formed in the form of a housing opened at an upper portion thereof and having therein a vacant space S, and a filter 200 to be described below may be detachably mounted in the vacant space S.

As an exemplary embodiment, an air intake unit 110 may be provided on an outer surface of the lower body 100, and the air intake unit 110 is configured to draw in outside contaminated air. Specifically, as illustrated in FIGS. 1 and 2, the air intake unit 110 may be provided on an entire surface of the lower body 100 by 360 degrees along an outer circumference of the lower body 100, thereby drawing in the contaminated air in all directions. Therefore, it is possible to draw in the outside contaminated air in all directions without being restricted by an environment in which the air purification device 10 is used.

As an exemplary embodiment, the air intake unit 110 may include through members (not illustrated) such as inlet holes or inflow slits each having a predetermined size and penetratively formed so that the contaminated air is introduced through the through members.

As an exemplary embodiment, at least one coupling groove (not illustrated) may be formed at a part of a circumference at the opened upper portion of the lower body 100. The coupling groove is configured to provide a structure rigidly coupled to the filter 200 to be described below, and a state in which the filter 200 is inserted into the vacant space of the lower body 100 may be intuitively ascertained. The structure for coupling the lower body 100 and the filter 200 by means of the coupling groove will be described in detail below together with the description of the filter 200.

As an exemplary embodiment, multiple wheels 600 may be provided on a lower portion of the lower body 100 in order to allow the air purification device 10 to be easily moved.

As an exemplary embodiment, as illustrated in FIG. 2, a contact unit 120 may be provided on a circumferential surface of an upper portion of the lower body 100, and the contact unit 120 is a part that comes into contact with the upper body 300 to be described below so that the lower body 100 is coupled to the upper body 300. Therefore, the lower body 100 and the upper body 300 of the air purification device 10 may be more securely coupled. According to the exemplary embodiment, electric power supplied to the lower body 100 may be transmitted to the upper body 300 through the contact unit 120. Meanwhile, the contact unit 120 may not be provided on the lower body 100 in a case in which electric power supplied from the outside is transmitted directly to the upper body 300.

The filter 200 may be inserted into the vacant space of the lower body 100 and may purify the air drawn into the lower body 100.

Specifically, as illustrated in FIG. 3, a shape of the filter 200 may correspond to a shape of the vacant space formed in the lower body 100. In the present exemplary embodiment, the filter 200 may have a cylindrical shape.

As an exemplary embodiment, the filter 200 may perform a filtering function in all directions at 360 degrees along an outer side of the filter 200.

As an exemplary embodiment, separation members 400 each having a label shape may be provided around an upper portion of the filter 200 so that a user may separate the filter 200 by lifting up the filter 200 from the lower body 100.

As an exemplary embodiment, one side of the separation member 400 may be coupled to a circumference of the opened upper portion of the lower body 100, and the other side of the separation member 400 may protrude from the upper portion of the lower body 100 in a direction in which the upper portion of the lower body 100 is opened.

Therefore, a part of the separation member 400 may be exposed to the outside in the state in which the filter 200 is inserted into the lower body 100.

As an exemplary embodiment, multiple pairs of separation members 400 may be provided around the opened upper portion of the lower body 100 so as to face one another. With this structure, when the user intends to separate the filter 200, inserted into the vacant space of the lower body 100, from the lower body 100 in order to replace or clean the filter 200, the user may separate the filter 200 by holding and lifting up the separation member 400 exposed to the outside.

As an exemplary embodiment, the lower bodies 100 having different sizes may be interchangeable. In addition, the lower body 100 may of course be coupled to the upper body 300 without being restricted by the implemented size. Therefore, the upper body 300 may be used together with the interchangeable lower bodies 100 having different capacities.

In this case, various output functions of the air purification device 10 may be automatically set in accordance with the capacities of the lower bodies 100 interchangeably used with the upper body 300 as the lower bodies 100 are implemented to have different sizes.

As an exemplary embodiment, a rotational speed of a fan of the air purification device 10 may be automatically set in accordance with the capacities of the interchangeable lower bodies 100. For example, the rotational speed of the fan may be automatically set such that the rotational speed of the fan is increased as the capacity of the interchangeable lower body 100 is increased and an air purification range of the air purification device 10 is increased.

As another exemplary embodiment, a dehumidification period of the air purification device may be automatically set in accordance with the capacity of the interchangeable lower body 100. For example, the dehumidification period may be automatically set such that the dehumidification period is increased as the capacity of the interchangeable lower body 100 is increased and the dehumidification period of the air purification device 10 is increased.

For reference, the output function of the air purification device 10 may be automatically set by a control unit to be described below.

The upper body 300 is opened at an upper portion thereof, and the lower portion of the upper body 300 may be brought into contact with and coupled to the opened upper portion of the lower body 100.

As an exemplary embodiment, the lower body 100 and the upper body 300 may be coupled by means of magnetic members having different magnetic polarities and provided on a circumferential surface of the lower body 100 and a circumferential surface of the upper body 300 which are brought into contact with each other. For example, the magnetic member having the S-polarity may be provided on an upper circumferential surface of the lower body 100, and the magnetic member having the N-polarity may be provided on a lower circumferential surface of the upper body 300, such that the lower body 100 and the upper body 300 may be coupled to each other. For reference, the structure for coupling the lower body 100 and the upper body 300 is not limited thereto, and various coupling structures may be applied.

As an exemplary embodiment, a lower circumference of the upper body 300 and an upper circumference of the lower body 100 may correspond in size to each other.

As an exemplary embodiment, an air discharge unit having a dual fan cover structure may be provided on the upper portion of the upper body 300, and the air discharge unit is configured to discharge the purified air.

Specifically, as illustrated in FIG. 5, the air discharge unit has a structure in which two fan covers are coupled, and the air discharge unit may include a blower fan (not illustrated), a first fan cover 322, and a second fan cover 324.

The blower fan is provided in the upper body 300 and may guide a flow of air so that the air purified by the filter 200 is discharged to the outside. Because the blower fan is a general component applied to the air purification device 10, a detailed description thereof will be omitted.

The first fan cover 322 may be provided on the upper portion of the upper body 300 and may cover a front side of the blower fan. In this case, the first fan cover 322 may be detachably coupled to the upper portion of the upper body 300.

As an exemplary embodiment, the first fan cover 322 may include a first discharge port 323 in the form of a mesh.

The second fan cover 324 may be provided on the upper body 300 and may doubly cover the blower fan. In other words, the second fan cover 324 may be provided to be spaced apart from a front side of the first fan cover 322 at a predetermined interval.

As an exemplary embodiment, the second fan cover 324 may include a second discharge port 325 having slits formed at an equal interval.

With this structure, both of the first fan cover 322 and the second fan cover 324 may be detachably provided on the upper portion of the upper body 300, as a result of which it is possible to separately detach only the fan from the body of the air purification device 10 and thus to replace and clean the fan.

Furthermore, the dual-structure fan cover including the first fan cover 322 and the second fan cover 324 is mounted on the upper body 300 to cover the interior of the air purification device 10, as a result of which it is possible to protect the blower fan from foreign substances or an environment outside the air purification device 10.

Further, the application of the dual-structure fan cover structure may reduce noise that occurs when the blower fan provided in the body of the air purification device 10 operates.

Meanwhile, although not illustrated in the drawings, a power source unit may be provided on the lower portion of the lower body 100, and a power supply line connected to the power source unit may penetrate the interior of the lower body 100 and then may be connected to the interior of the upper body 300.

The power supply line may be an electric power supply source for operating various types of electronic circuits such as a motor and a converter provided in the upper body 300. Here, the various types of electronic circuits are components for operating the air purification device 10 and may be provided only in the upper body 300.

A slot portion 500 may be provided in a circumferential surface of the upper body 300, and a chip capable of cooperating with an IoT (Internet of things) module may be mounted in the slot portion 500. In this case, the chip mounted in the slot portion 500 may be a wireless chip and may cooperate with the IoT module such as an AI speaker or a smart device in a wireless manner.

As an exemplary embodiment, in order to check for a state of charge of a battery of the air purification device 10 from a location remote, at a predetermined distance, from the air purification device 10, the wireless chip mounted in the slot portion 500 may cooperate with the AI speaker, thereby providing the user with aural information.

At least one sensor (not illustrated) such as a temperature/humidity sensor for detecting a temperature/humidity environment outside or inside the air purification device 10 or a dust sensor for detecting an environment of outside air quality may be provided on a circumference of the upper body 300, but the present invention is not limited thereto, and various detecting sensors such as an illumination intensity sensor may be further provided. For reference, the sensor may be implemented in the form of a button.

The temperature/humidity sensor and the dust sensor may be electrically connected to the control unit (not illustrated) configured to control the operation of the air purification device 10. For reference, although not illustrated in the drawings, the control unit may operate by being supplied with electric power from the battery mounted outside the air purification device 10 and connected to the air purification device 10 or mounted inside the air purification device 10.

As an exemplary embodiment, the control unit may control the operation of the air purification device 10 based on detection results of the temperature/humidity sensor and the dust sensor. For example, when it is determined that concentration of outside carbon dioxide detected by the dust sensor is equal to or greater than a critical value, the control unit may control the filter 200 of the air purification device 10 so that the filter 200 operates strongly.

Meanwhile, the wireless chip mounted in the slot portion 500 cooperates with the temperature/humidity sensor and the dust sensor, such that the sensors may also be operated by the IoT module in addition to the control unit.

As an exemplary embodiment, when the user intends to manually control humidity in a room which is automatically controlled based on the detection result of the humidity sensor, the user may manipulate his/her smart device to optionally change a dehumidification performance of the air purification device 10. For example, if the user wants a higher humidity environment, the user may manipulate the smart device to enable the humidity sensor, which operates in a wireless manner, to perform a stronger dehumidification function.

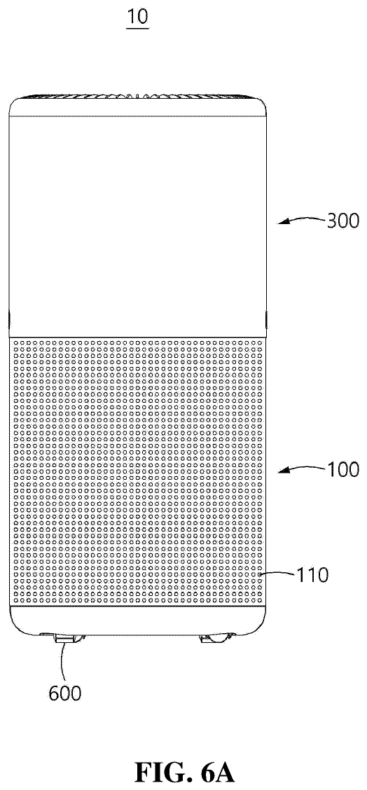

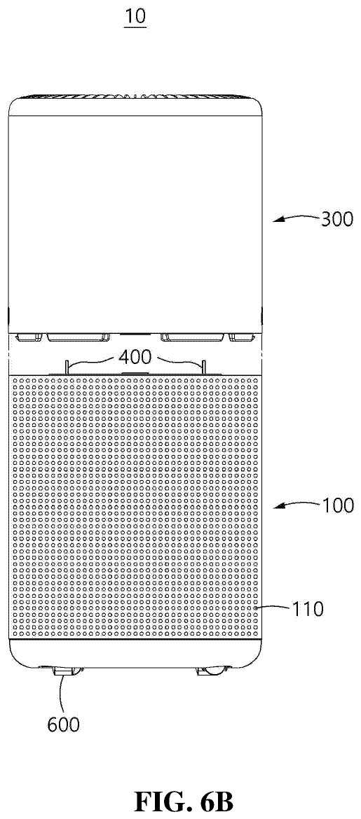

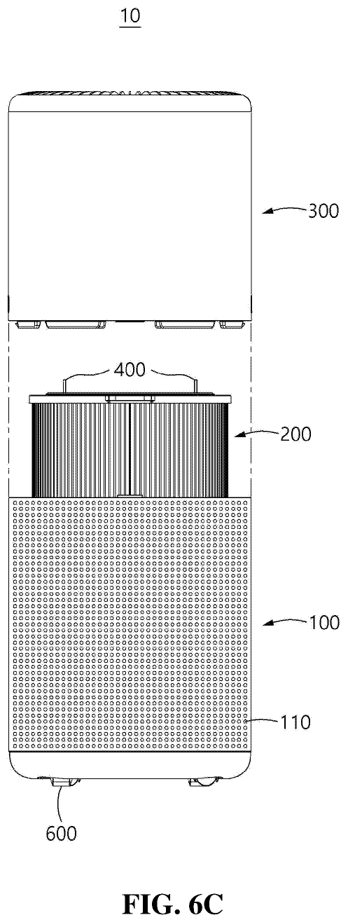

FIGS. 6A to 6C are front views for explaining a process of disassembling the air purification device according to the exemplary embodiment of the present invention.

First, referring to FIG. 6A, in the air purification device 10 of the present invention, the upper circumference of the lower body 100 and the lower circumference of the upper body 300 are brought into contact with each other, such that the lower body 100 and the upper body 300 may be coupled to each other. In this case, the lower body 100 and the upper body 300 may be coupled by means of the magnetic members having different magnetic polarities and provided on the circumferential surface of the lower body 100 and the circumferential surface of the upper body 300 which come into contact with each other.

Further, referring to FIG. 6B, it can be ascertained that the separation members 400 provided on the upper circumference of the filter 200 inserted into the lower body 100 are partially exposed in the state in which the lower body 100 and the upper body 300 are separated from each other.

Further, referring to FIG. 6C, the user may draw out the filter 200, inserted into the lower body 100, by holding and lifting up the exposed part of the separation member 400.

While the specific exemplary embodiments according to the present invention have been described above, various modifications may be made without departing from the scope of the present invention. Therefore, the scope of the present invention should not be limited to the described exemplary embodiments and should be defined by not only the claims to be described below, but also those equivalent to the claims.

While the present invention has been described above with reference to the limited exemplary embodiments and the drawings, the present invention is not limited to the exemplary embodiments and may be variously modified and altered from the disclosure by those skilled in the art to which the present invention pertains. Therefore, the spirit of the present invention should be defined only by the appended claims, and all modifications, equivalents, and alternatives fall within the scope and spirit of the present invention.

1. An air purification device including an interchangeable lower body, the air purification device comprising:
an upper body opened at an upper portion thereof, selectively having therein an electronic circuit configured to operate the air purification device, and having, at the upper portion thereof, an air discharge unit configured to discharge purified air, the upper body being configured to be connected to one of interchangeable lower bodies having different capacities; and
the lower body opened at an upper portion thereof and coupled to the upper body by being brought into contact with a lower portion of the upper body, the lower body having a vacant space into which a filter configured to purify air is inserted, selectively having therein an electronic circuit configured to operate the air purification device, and having an air intake unit provided on an outer surface thereof to draw in contaminated air.

2. The air purification device of claim 1, wherein the air intake unit is provided on an entire surface along an outer circumference of the lower body and draws in the contaminated air in all directions at 360 degrees.

3. The air purification device of claim 1, wherein the lower bodies are implemented to have different sizes and to be interchangeable.

4. The air purification device of claim 3, wherein a rotational speed of a fan of the air purification device is automatically set based on a capacity of the interchangeable lower body.

5. The air purification device of claim 1, wherein a separation member having a label shape is provided on an upper circumference of the filter in order to lift up and separate the filter from the lower body.

6. The air purification device of claim 5, wherein a part of the separation member is exposed to the outside in a state in which the filter is inserted into the lower body.

7. The air purification device of claim 1, wherein the air discharge unit comprises:
a blower fan provided in the upper body and configured to induce a flow of air so that the purified air is discharged to the outside;
a first fan cover provided on the upper portion of the upper body and configured to cover a front side of the blower fan; and
a second fan cover provided on an upper portion of the first cover and configured to doubly cover the blower fan.

8. The air purification device of claim 7, wherein the first fan cover comprises a first discharge port in the form of a mesh, and the second fan cover comprises a second discharge port having slits formed at an equal interval.

9. The air purification device of claim 1, wherein the lower body and the upper body are coupled by means of magnetic members having different magnetic polarities and provided on a circumferential surface of the lower body and a circumferential surface of the upper body which are brought into contact with each other.

10. The air purification device of claim 1, wherein a slot portion is provided in a circumferential surface of the upper body, and a chip configured to cooperate with an IoT (Internet of things) module is mounted in the slot portion.

11. The air purification device of claim 1, wherein at least one of a temperature/humidity sensor configured to detect a temperature/humidity environment outside or inside the air purification device and a dust sensor configured to detect an environment of outside air quality is provided on a circumference of the upper body, and the air purification device further comprises a control unit configured to control an operation of the air purification device based on detection results of the temperature/humidity sensor and the dust sensor.

12. An air purification device including an interchangeable lower body, the air purification device comprising:
an upper body opened at an upper portion thereof and having, at the upper portion thereof, an air discharge unit configured to discharge purified air, the upper body being configured to be connected to one of interchangeable lower bodies having different capacities; and
the lower body opened at an upper portion thereof and coupled to the upper body by being brought into contact with a lower portion of the upper body, the lower body having a vacant space into which a filter configured to purify air is inserted, and having an air intake unit provided on an outer surface thereof to draw in contaminated air, wherein the air discharge unit comprises:
a blower fan provided in the upper body and configured to induce a flow of air so that the purified air is discharged to the outside;
a first fan cover provided on the upper portion of the upper body and configured to cover a front side of the blower fan; and
a second fan cover provided on an upper portion of the first cover and configured to doubly cover the blower fan.
